(19) United States
(12) Patent Application Publication
(10) Pub. No.: US 2026/0352776 A1
(43) Pub. Date: Nov. 5, 2026

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: AKIRA SANDAMBATA, Kanagawa (JP)

(21) Appl. No.: 19/655,435

(22) Filed: Apr. 22, 2026

(30) Foreign Application Priority Data
May 2, 2025 (JP) 2025-076788

(51) Int. Cl. H04N 5/272; G06T 7/194; G06T 7/246; G06T 7/73

(52) U.S. Cl. CPC H04N 5/272; G06T 7/194; G06T 7/251; G06T 7/75; G06T 2207/10016; G06T 2207/30196

(57) ABSTRACT

An apparatus includes at least one processor and at least one memory coupled to the at least one processor storing instructions that, when executed by the at least one processor, cause the at least one processor to function as an acquisition unit configured to acquire a first image and a second image, a determination unit configured to determine either the first image or the second image to be a foreground image based on an importance degree and a threshold importance degree set for the second image, and a composition unit configured to composite the first image and the second image based on a result of the determination performed by the determination unit.

### BACKGROUND

### Field of the Technology

The aspect of the embodiments relates to an image processing apparatus, an image processing method, and a storage medium.

### Description of the Related Art

Conventionally, a composite image generated by compositing a plurality of images, such as display images including background images, presentation materials, and photos, and moving images of persons may be produced in television studios and other image production sites. For example, in some cases, a display image for presentation created using a computer or the like is superimposed on a background image, such as a plain image, an image having a uniform pattern, or a photo, and further, a moving image of a person captured against a green background at another location is superimposed. In this case, due to movement or gesture of the person, the person may overlap the region of the display image for presentation. At this time, for example, in a case where a person is always set in the foreground, the display image for presentation may be occluded by the person. In contrast, in a case where the display image is always set in the foreground, the person may be occluded by the display image.

Japanese Patent Laid-Open No. 2016-119567 describes a technique in which images are captured from different angles using a plurality of imaging devices, and a region occluded by a person is complemented using images captured by other imaging devices, enabling the foreground image to be freely switched between an image of the person and an image as a presentation material or the like.

However, in the technique described in Japanese Patent Laid-Open No. 2016-119567, even in a case where the user who creates composite images or the like intends to place a person in the foreground, an image as a presentation material or the like may be placed in the foreground, obscuring the image of the person.

### SUMMARY

According to an aspect of the embodiments, an image processing apparatus includes at least one processor and at least one memory coupled to the at least one processor storing instructions that, when executed by the at least one processor, cause the at least one processor to function as an acquisition unit configured to acquire a first image and a second image, a determination unit configured to determine either the first image or the second image to be a foreground image based on an importance degree and a threshold importance degree set for the second image, and a composition unit configured to composite the first image and the second image based on a result of the determination performed by the determination unit.

Features of the disclosure will become apparent from the following description of embodiments with reference to the attached drawings. The following description of embodiments is described by way of example.

### BRIEF DESCRIPTION OF THE DRAWINGS

FIG. 1A is a diagram illustrating an example of a functional configuration of an image processing apparatus.

FIG. 1B is a diagram illustrating an example of a hardware configuration of the image processing apparatus.

FIG. 2 is a diagram for describing a setting example of an importance degree and a threshold importance degree.

FIG. 3 is a diagram illustrating an example of a composite image in a case where a display image and a person do not overlap.

FIG. 4 is a diagram illustrating an example of a composite image in a case where an importance degree of a display image is equal to or larger than a threshold importance degree.

FIG. 5 is a diagram illustrating an example of a composite image in a case where an importance degree of a display image is smaller than a threshold importance degree.

FIG. 6 is a flowchart illustrating image processing according to a first embodiment.

FIG. 7 is a diagram for describing a setting example of importance degrees of a plurality of display regions and a threshold importance degree.

FIG. 8 is a diagram illustrating an example of a composite image in a case where an importance degree of a display region is equal to or larger than a threshold importance degree.

FIG. 9 is a diagram illustrating an example of a composite image in a case where an importance degree is smaller than a threshold importance degree.

FIG. 10 is a flowchart illustrating image processing according to a second embodiment.

FIG. 11 is a diagram illustrating an example of a composite image in a case where the area of an overlap region is equal to or smaller than a threshold area.

FIG. 12 is a diagram illustrating an example of a composite image in a case where the area of an overlap region is larger than a threshold area.

FIG. 13 is a flowchart illustrating image processing according to a third embodiment.

FIG. 14 is a diagram for describing an example of a display region division that uses a trained model, and an importance degree setting.

FIG. 15 is a flowchart illustrating image processing according to a fourth embodiment.

FIG. 16 is a flowchart illustrating image processing according to a fifth embodiment.

FIGS. 17A - 17E are diagrams illustrating examples of composite images in which the transparency of persons is changed based on the overlap time period.

### DESCRIPTION OF THE EMBODIMENTS

Some embodiments of the disclosure will now be described with reference to the drawings. The following embodiments are not intended to limit the disclosure, and not all the combinations of features described in the embodiments are necessarily essential to the solution described in the disclosure. The configurations of the embodiments can be appropriately modified or changed depending on the specifications of an apparatus to which the disclosure is applied, and various conditions (use conditions, usage environment, etc.). In addition, the embodiments to be described below may be partially combined as appropriate. In the following embodiments, the redundant description of the same or similar configurations and processing processes will be omitted.

### First Embodiment

In a first embodiment, an apparatus that acquires a first image and a second image to generate and output a composite image by compositing the first image and the second image will be described as an example of an image processing apparatus. In the embodiment, the image processing apparatus will be described as an example that generates a composite image by compositing a plurality of images including an image of a person as an example of the first image, a display image, such as a presentation material or a photo, and a background image as an example of the second image, in a television studio or another image production site.

Examples of the background image include a plain image, an image having a uniform pattern, and a photo to increase visibility. Further, examples of a display image, such as a presentation material or a photo, include an image for presentation created using a computer or the like. An image of a person is assumed to be a moving image of a person captured against a green background or a blue background using an imaging device, such as a video camera at another site. The person is described as a presenter who gives a presentation using presentation materials or the like. The image processing apparatus according to the embodiment generates a composite image by compositing these images, and outputs the composite image to an image output device, such as a display or a television (TV) monitor. A device to be used for image input and output is not limited to these devices. Further, the use cases of the image processing apparatus according to the embodiment are not limited to being used in an image production site or the like.

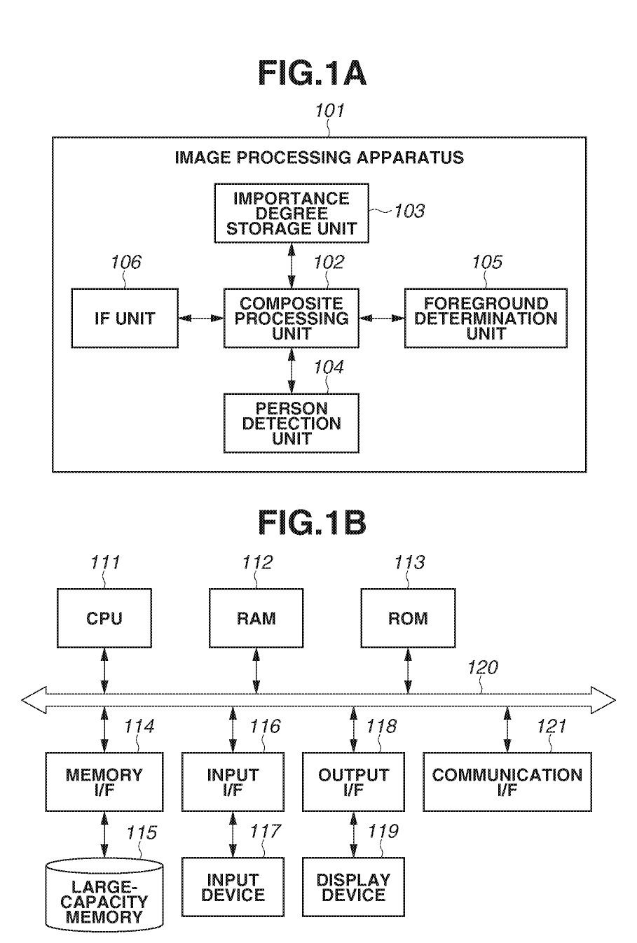

FIGS. 1A and 1B are diagrams each illustrating a configuration example of the image processing apparatus according to the first embodiment. FIG. 1A is a diagram illustrating a functional configuration of the image processing apparatus, and FIG. 1B is a diagram illustrating a hardware configuration example to implement the image processing apparatus. The configurations illustrated in FIGS. 1A and 1B are common to the embodiments described below.

The functional configuration of the image processing apparatus illustrated in FIG. 1A will now be described.

An interface (IF) unit 106 is used, for example, to input and output images, and input an importance degree and a threshold for an importance degree (hereinafter, referred to as a threshold importance degree), both of which will be described below. In the example of the embodiment, images to be input to the IF unit 106 include a moving image of a person as an example of the first image, a display image for presentation, such as a presentation material or a photo as an example of the second image, and a background image, such as a plain image, an image having a uniform pattern, or a photo.

The IF unit 106 transmits input image data to a composite processing unit 102 described below. Further, the IF unit 106 transmits data about a composite image generated by the composite processing unit 102 described below to an external device. Examples of the external device to which the data about the composite image is transmitted include a display, and a personal computer (PC). The importance degree and the threshold importance degree to be input to the IF unit 106 are information that is preset by the user for a display image for presentation, such as a presentation material or a photo, which is an example of the second image. In the embodiment, the importance degree and the threshold importance degree are set by the user using, for example, a not-illustrated external device, such as a switcher or a controller, or an application on a PC, to be input to the IF unit 106. Alternatively, in a case where an image processing apparatus 101 includes a touch panel, an operation button, and the like, the importance degree and the threshold importance degree may be set via an operation performed by the user on the touch panel or the operation button. Information regarding the importance degree and the threshold importance degree input to the IF unit 106 is then stored in an importance degree storage unit 103 described below via the composite processing unit 102.

Examples of image input interface standards for the IF unit 106 include serial digital interface (SDI), and high-definition multimedia interface (HDMI®). Alternatively, other image input interface standards may be, for example, video graphics array (VGA), digital visual interface (DVI), DisplayPort, and local area network (LAN), and the image input interface standards are not limited to these.

An image output interface is assumed to be an interface similar to the image input interface, but the image output interface is also not limited thereto.

The importance degree storage unit 103 stores information regarding an importance degree and a threshold importance degree input from the IF unit 106 via the composite processing unit 102. An importance degree and a threshold importance degree are parameters associated with each image and a region in the corresponding image to perform image processing according to the embodiment. Usage examples of the importance degree and the threshold importance degree will be described below. The importance degree storage unit 103 includes a volatile memory or a nonvolatile memory as a memory for storing an importance degree and a threshold importance degree. Examples of the volatile memory include a dynamic random access memory (DRAM), and a static random access memory (SRAM). Further, examples of the nonvolatile memory include an electrically erasable programmable read-only memory (EEPROM), and a flash memory. These volatile memories and nonvolatile memories are examples, and these memories are not limited to these.

A person detection unit 104 is a calculation unit that detects a person as a target object from a moving image input to the composite processing unit 102 to calculate position information about the person in the image. The person detection unit 104 does not necessarily need to be an independent module or an integrated circuit (IC), and may be a module provided in the composite processing unit 102.

The composite processing unit 102 performs composite processing of compositing a display image, a background image, and a moving image of a person input to the above-described IF unit 106. The composite processing will be described in detail below. The composite processing unit 102 according to the embodiment also performs processing of determining whether a display image and a region of a person overlap with each other, which will also be described in detail below.

In a case where the composite processing unit 102 determines that a region of a person and a display image overlap with each other, a foreground determination unit 105 determines which of the image of the person and the display image is to be placed in the foreground image. As will be described in detail below, in a case where the composite processing unit 102 determines that the display image with an importance degree equal to or larger than the threshold importance degree overlaps the person image, the foreground determination unit 105 determines based on the importance degree and the threshold importance degree which of the image of the person and the display image is to be placed in the foreground image.

The composite processing unit 102 then performs processing of compositing images based on an importance degree and a threshold importance degree set for a display image, a person detection result obtained by the person detection unit 104, and a foreground determination result obtained by the foreground determination unit 105. In the embodiment, for example, the composite processing unit 102 is assumed to be implemented with an arithmetic processing device, such as a central processing unit (CPU) 111. Alternatively, another arithmetic processing device that implements the composite processing unit 102 may be an Application Specific Integrated Circuit (ASIC) or a field programmable gate array (FPGA). These are merely examples, and the arithmetic processing device is not limited to the above-described examples.

The hardware configuration of the image processing apparatus illustrated in FIG. 1B will now be described. The hardware configuration illustrated in FIG. 1B is an example, and the hardware configuration is not limited to this example.

In FIG. 1B, the CPU 111 uses a random access memory (RAM) 112 as a working memory, and controls the operation of each component connected via a system bus 120 by, for example, executing a control program stored in a read-only memory (ROM) 113. Further, the CPU 111 reads data from a large-capacity memory 115 via a memory IF 114, and also writes data into the large-capacity memory 115. The CPU 111 performs operations of the functional units, such as the composite processing unit 102, the person detection unit 104, and the foreground determination unit 105 illustrated in FIG. 1A by loading an image processing program according to the embodiment from the large-capacity memory 115 into the RAM 112 to execute the image processing program.

The memory IF 114 connects to the large-capacity memory 115. The memory IF 114 is an interface (I/F), such as serial advanced technology attachment (SATA) or PCI Express (PCIe).

An input IF 116 connects to an input device 117 including a button and a key (not illustrated) that is mounted on or connected to the image processing apparatus 101. The input IF 116 may be a serial bus IF, such as universal serial bus (USB) or Institute of Electrical and Electronics Engineers (IEEE) 1394. The CPU 111 is capable of reading data from the input device 117 via the input IF 116.

An output IF 118 connects to a display device 119, such as a liquid crystal panel and an organic electroluminescent (EL) panel. A standard for the output IF 118 may be, for example, SDI, HDMI, VGA, DVI, DisplayPort, LAN, or the like, described above. The CPU 111 outputs a composite image composited by the composite processing unit 102 and an image input from the IF unit 106 to the display device 119 via the output IF 118.

A communication IF 121 is included in the above-described IF unit 106. The CPU 111 is capable of storing data input via the communication IF 121 in the large-capacity memory 115 or the like. Further, the CPU 111 is capable of transmitting data stored in the large-capacity memory 115 to the outside via the communication IF 121.

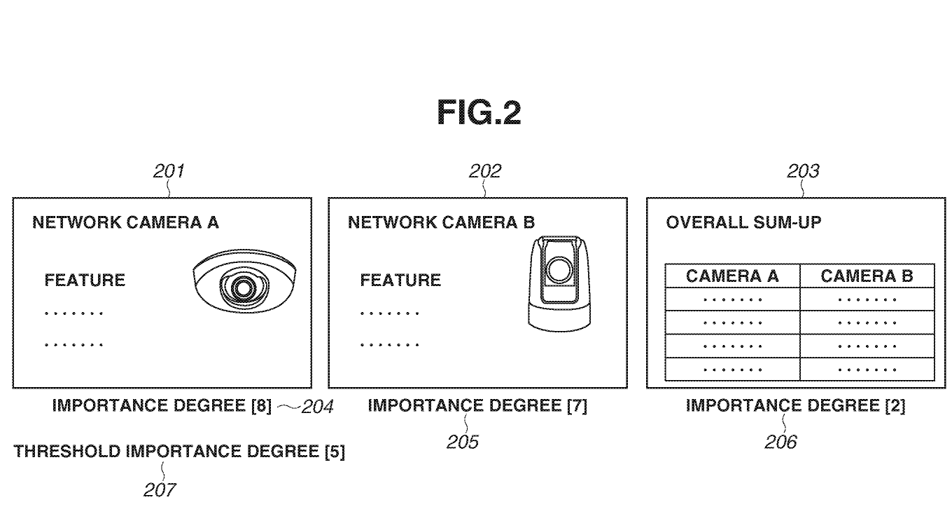

Image processing performed by the image processing apparatus 101 according to the first embodiment will now be described with reference to FIGS. 2, 3, and 4.

Display images 201, 202, and 203 in FIG. 2 are examples of images, such as presentation materials used by a presenter for presentation. In FIG. 2, the three display images are illustrated as examples. However, the number of display images is not limited to three, and may be one or two, or four or more, and there is no limitation on the number thereof. Before giving a presentation, the user sets an importance degree and a threshold importance degree for each display image.

An importance degree is a value indicating a degree to which a display image is prioritized as a foreground image, and a threshold importance degree is a value used as a threshold for switching so that a display image is placed in the foreground image over an image of a person.

In the example illustrated in FIG. 2, an importance degree 204 is set for the display image 201, an importance degree 205 is set for the display image 202, an importance degree 206 is set for the display image 203, and a threshold importance degree 207 is also set. FIG. 2 is a diagram for merely describing the setting of the importance degrees of the respective display images and the threshold importance degree, and is not intended to represent a graphical user interface (GUI).

In the embodiment, a value of an importance degree may be a numerical value, such as an absolute value, or may be a value indicating a relative priority order for each display image.

An example will be described where an absolute value is set as a value of an importance degree.

In the embodiment, an absolute value indicating a value of an importance degree is represented by a value, for example, on a ten-level scale. FIG. 2 illustrates an example in which the importance degree 204 of the display image 201 is set to "eight", the importance degree 205 of the display image 202 is set to "seven", and the importance degree 206 of the display image 203 is set to "two". Further, in a case where an absolute value is set as a value of an importance degree, an absolute value is also used as a threshold importance degree. In the example illustrated in FIG. 2, the threshold importance degree 207 is set to "five". Thus, in the example illustrated in FIG. 2, a relationship between the importance degrees of the respective display images and the threshold importance degree is such that the importance degree 204 of the display image 201 > the importance degree 205 of the display image 202 > the threshold importance degree 207 > the importance degree 206 of the display image 203. In other words, whereas the display image 201 and the display image 202 have importance degrees set to be equal to or larger than the threshold importance degree 207, the display image 203 has an importance degree set to be smaller than the threshold importance degree 207. In this example, the importance degrees 204 to 206 are classified into the importance degree equal to or larger than the threshold importance degree 207 and the importance degree smaller than the threshold importance degree 207, but the classification is not limited to this example. The importance degrees 204 to 206 may be classified into an importance degree or importance degrees exceeding the threshold importance degree 207 and an importance degree or importance degrees equal to or smaller than the threshold importance degree 207.

An example will be described in which a value indicating a relative priority order of each display image is set as an importance degree. In a case where a value indicating a relative priority order of each display image is set as an importance degree, values are used that allow importance degrees of display images to be relatively compared with each other.

In FIG. 2, for example, the priority order is set of the importance degree 204 of the display image 201 > the importance degree 205 of the display image 202 > the importance degree 206 of the display image 203, and the importance degree 205 of the display image 202 is set as the threshold importance degree 207. In this example, the display image 201 and the display image 202 have the importance degree 204 and the importance degree 205 equal to or larger than the threshold importance degree 207, respectively, whereas the display image 203 has the importance degree 206 smaller than the threshold importance degree 207. Further, in a case where a relative priority order is used, similarly to the above-described case where an absolute value is used, the importance degrees may be classified into an importance degree or importance degrees exceeding the threshold importance degree 207 and an importance degree or importance degrees equal to or smaller than the threshold importance degree 207.

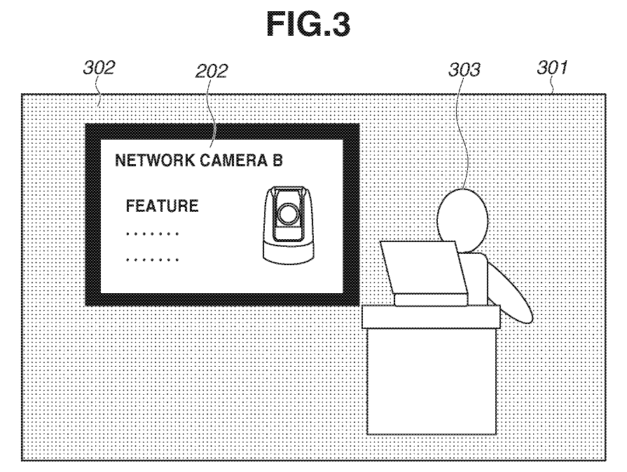

FIG. 3 is a diagram illustrating an example of a composite image in a case where a display image and the region of a person do not overlap each other. The example in FIG. 3 illustrates a composite image 301 in which the display image 202 illustrated in FIG. 2 is superimposed on a background image 302, and an image of a person 303 is further composited at a position not overlapping the display image 202. As described with reference to the example in FIG. 2, the display image 202 is assumed to have the importance degree 205 larger than the threshold importance degree 207. The image of the person 303 is a moving image captured in another studio, for example, using a chroma key background, such as a green background or a blue background. Further, in the example in FIG. 3, a plain or patterned still image is drawn as the background image 302, but the background image 302 may be an image or a moving image of a scenery or the like. In the case of a positional relationship between the display image 202 and the person 303 illustrated in the example in FIG. 3, the person 303 is positioned at a position separate from the display image 202, and thus no overlap occurs. In this example, since no overlap occurs between the person 303 and the display image 202, the foreground determination unit 105 of the image processing apparatus 101 does not determine which of the person 303 and the display image 202 is to be placed in the foreground image.

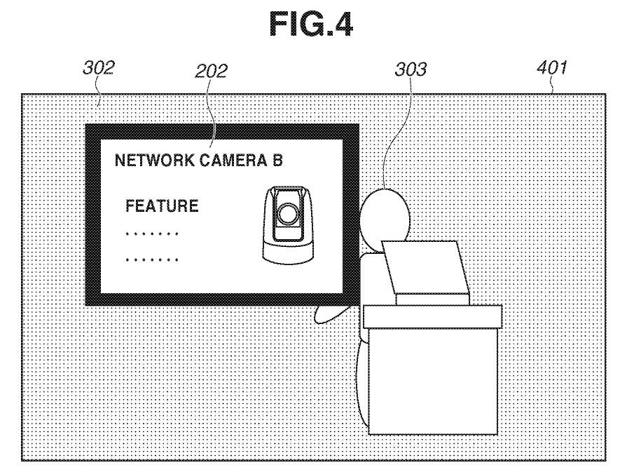

FIG. 4 is a diagram illustrating an example of a composite image 401 in a case where the importance degree of a display image is set to, for example, a value larger or relatively larger than a threshold importance degree with a person and a region of the display image overlapping each other. The example in FIG. 4 illustrates the composite image 401 in which the display image 202 illustrated in FIG. 2 superimposed on the background image 302 partially overlaps the person 303. As illustrated in the example in FIG. 2, the importance degree 205 of the display image 202 is set to a value larger (or a value relatively larger) than the threshold importance degree 207.

In a case where the display image 202 overlaps the partial region of the person 303 as illustrated in FIG. 4, the composite processing unit 102 determines that an overlap occurs between the display image 202 and the partial region of the person 303 based on the positional relationship between the person 303 and the display image 202. The composite processing unit 102 then transmits information regarding the importance degree 205 and the threshold importance degree 207 to the foreground determination unit 105 together with the overlap determination result.

The foreground determination unit 105 determines which of the person 303 and the display image 202 is to be placed in the foreground image based on the overlap determination result obtained by the composite processing unit 102, the importance degree 205, and the threshold importance degree 207. In this example, since the importance degree 205 of the display image 202 is larger than the threshold importance degree 207, the foreground determination unit 105 determines to set the display image 202 as the foreground image, and then transmits the determination result to the composite processing unit 102.

The composite processing unit 102 performs processing of compositing the display image 202 and the image of the person 303 with the display image 202 being set as a foreground image based on the determination result obtained by the foreground determination unit 105. Further, while FIG. 4 illustrates an example where a partial region of the display image 202 overlaps a partial region of the person 303, the image processing apparatus 101 performs similar processing irrespective of the size of an overlap region.

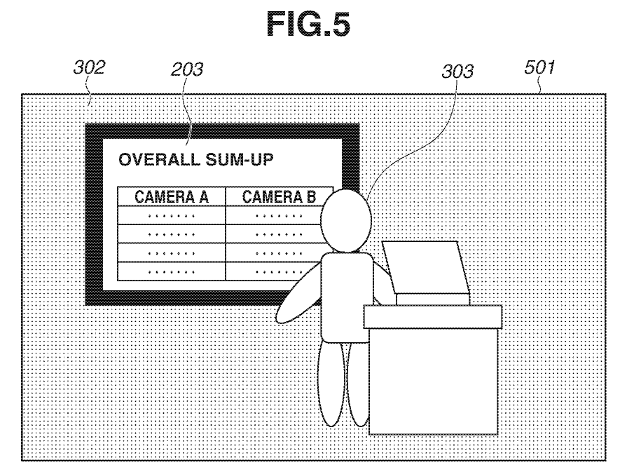

FIG. 5 is a diagram illustrating an example of a composite image 501 in a case where a person and a region of a display image overlap each other, and for example, the importance degree of the display image is set to a value smaller or relatively smaller than a threshold importance degree. The example in FIG. 5 illustrates the composite image 501 in which the display image 203 illustrated in FIG. 2 superimposed on the background image 302 partially overlaps the person 303. As illustrated in the example in FIG. 2, the importance degree 206 of the display image 203 is set to a value smaller (or a value relatively smaller) than the threshold importance degree 207.

In a case where the display image 203 and the partial region of the person 303 overlap as illustrated in FIG. 5, the composite processing unit 102 determines that an overlap occurs between the display image 203 and the partial region of the person 303 based on the positional relationship between the person 303 and the display image 203. The composite processing unit 102 then transmits information regarding the importance degree 206 and the threshold importance degree 207 to the foreground determination unit 105 together with the overlap determination result.

The foreground determination unit 105 determines which of the person 303 and the display image 203 is to be placed in the foreground image based on the overlap determination result obtained by the composite processing unit 102, the importance degree 206, and the threshold importance degree 207. In this example, since the importance degree 206 of the display image 203 is smaller than the threshold importance degree 207, the foreground determination unit 105 determines to set the image of the person 303 as the foreground image, and then transmits the determination result to the composite processing unit 102.

The composite processing unit 102 performs processing of compositing the image of the person 303 and the display image 203 with the image of the person 303 being set as the foreground image based on the determination result obtained by the foreground determination unit 105. Further, while FIG. 5 illustrates an example where a partial region of the display image 203 overlaps a partial region of the person 303, the image processing apparatus 101 performs similar processing irrespective of the size of an overlap region.

In FIGS. 3, 4, and 5, for the sake of simplicity of description, an example is described in which a display image and an image of a person are composited, but a plurality of display images may be composited, or images of a plurality of persons may be composited. Further, in a case where images of a plurality of persons are composited, a plurality of threshold importance degrees each corresponding to the corresponding person of the plurality of persons may be set. A plurality of threshold importance degrees each corresponding to the corresponding person of the plurality of persons set in this manner allows the foreground determination unit 105 to determine whether the image of each person is to be placed in the foreground image.

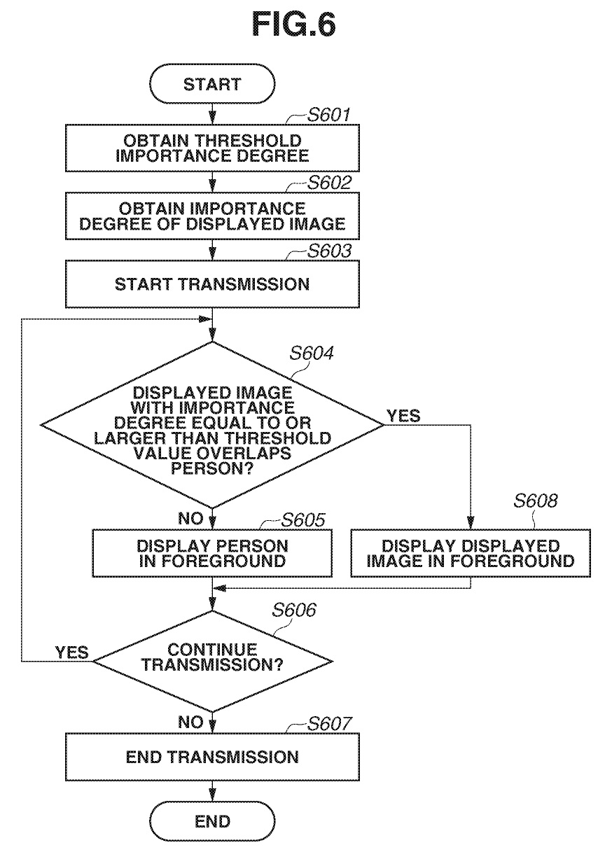

FIG. 6 is a flowchart illustrating a procedure for image processing performed by the image processing apparatus 101 according to the first embodiment.

In step S601, the importance degree storage unit 103 obtains a threshold importance degree set by the user using a desired method as described above and input from the IF unit 106 to store the threshold importance degree.

In step S602, the importance degree storage unit 103 obtains an importance degree set by the user for each display image using a desired method and input from the IF unit 106 to store the importance degree.

Further, the order of steps S601 and S602 may be reversed.

In step S603, after the storage of the importance degree and the threshold importance degree described above, the image processing apparatus 101 starts transmitting an image from the IF unit 106. During the image transmission, the image processing apparatus 101 performs person detection with the person detection unit 104 at a regular cycle, and performs processing of transmitting position information about the detected person to the composite processing unit 102.

In step S604, the composite processing unit 102 determines whether the importance degree of a display image is equal to or larger than the threshold importance degree (or may be larger than the threshold importance degree), and further determines whether a display image having an importance degree equal to or larger than the threshold importance degree overlaps a region of the person. Then, in a case where the composite processing unit 102 determines that a display image having an importance degree equal to or larger than the threshold importance degree overlaps a region of the person (YES in step S604), the processing proceeds to step S608; Otherwise (NO in step S604), the processing proceeds to step S605.

If the processing proceeds to step S608, i.e., if a display image having an importance degree equal to or larger than the threshold importance degree overlaps a region of the person, in step S608, the foreground determination unit 105 determines to display the display image in the foreground based on the importance degree and the threshold importance degree. The composite processing unit 102 then generates a composite image by compositing the display image and the image of the person with the display image being placed in the foreground based on the determination result.

On the other hand, if the processing proceeds to step S605, in step S605, the foreground determination unit 105 determines to display the image of the person in the foreground without determining which image is to be set as the foreground image based on the importance degree and the threshold importance degree, and the composite processing unit 102 generates a composite image by compositing the display image and the image of the person with the image of the person being placed in the foreground. Thus, in a case where a display image with an importance degree equal to or larger than the threshold importance degree does not overlap a person, or in a case where the importance degree of a display image overlapping a person is smaller than the threshold importance degree, the foreground determination unit 105 determines to display the image of the person in the foreground, and the composite processing unit 102 generates a composite image in which the person is in the foreground.

In the embodiment, while an example is described of performing foreground and background determination in a case where a display image with an importance degree equal to or larger than a threshold importance degree overlaps a person, the foreground and background determination based on the importance degree and the threshold importance degree may also be performed in a case where the display image with the importance degree does not overlap the person. Thus, although it is difficult to visually recognize a foreground and background relationship between the person image and the display image from a composited image, the image processing apparatus 101 performs relative foreground and background ordering of a person image and a display image also in a case where the person image and the display image do not overlap. As a result, in a case where the person image and a region of the display image overlap later, the user can visually recognize the foreground and background relationship between the person image and the display image.

After step S608 or step S605, the processing of the image processing apparatus 101 proceeds to step S606. When the processing proceeds to step S606, in step S606, the IF unit 106 monitors a signal input from the outside to determine whether to continue transmission of the composite image. If the IF unit 106 determines to continue transmission of the composite image (YES in step S606), the processing of the image processing apparatus 101 returns to step S604. On the other hand, if the IF unit 106 determines to end the transmission of the composite image (NO in step S606) by monitoring a signal input from the outside, the processing proceeds to step S607. In step S607, the processing of this flowchart ends.

As described above, according to the image processing apparatus 101 of the first embodiment, which of a display image and a person in a moving image is to be displayed as the foreground is selected based on an importance degree and a threshold importance degree set by the user. This makes it possible to generate a composite image that reflects the intention of the user.

### Second Embodiment

As a second embodiment, a case will be described in which one display image is divided into a plurality of image regions based on a setting configured by the user, and importance degrees are respectively set for the plurality of image regions. In the following description, image regions obtained by dividing a display image into a plurality of image regions will be referred to as display regions.

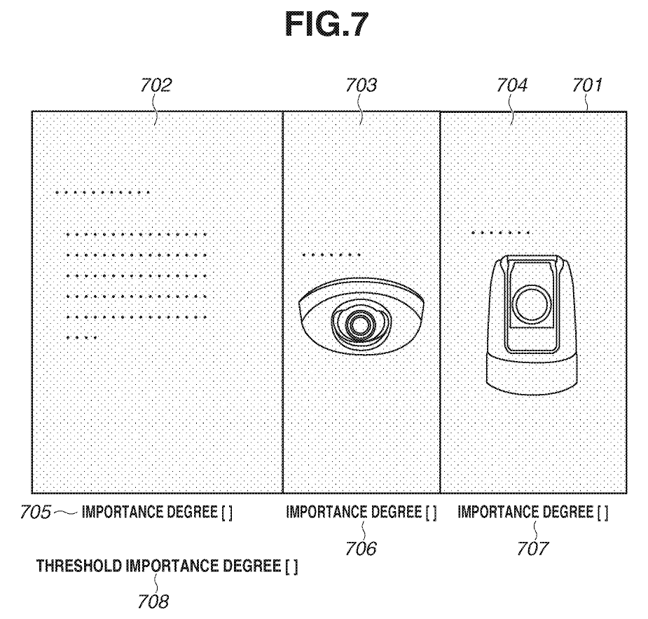

FIG. 7 is a diagram illustrating an example of a display image 701 of presentation material used by a presenter for presentation according to the second embodiment. The display image 701 exemplified in FIG. 7 is an image representing a presentation slide to be used in, for example, a presentation.

The display image 701 is divided into three display regions 702, 703, and 704 based on a setting configured by the user. Further, it is on the assumption that an importance degree 705 is set by the user for the display region 702, an importance degree 706 is set for the display region 703, and an importance degree 707 is set for the display region 704, and a threshold importance degree 708 is also set. In the example in FIG. 7, while the display image 701 is divided into three display regions corresponding to the display regions 702 to 704, the number of display regions is not limited to three. Further, in the example illustrated in FIG. 7, while the display image 701 is divided into rectangular display regions, the shapes of the divided display regions are not limited to rectangular shapes, and may be any shape. Further, the division may be, for example, made for each object in the display image 701, or based on the details of displayed information or the amount of information. In the example illustrated in FIG. 7, while only one display image is illustrated, a plurality of display images may be provided. In this case, different importance degrees and threshold importance degrees may be set among display regions of individual display images.

In the embodiment, in a case where the display image 701 and the image of the person 303 overlap each other, the image processing apparatus 101 determines whether to display each of the display regions 702 to 704 of the display image 701 in the foreground based on the importance degrees and the threshold importance degree of the display regions 702 to 704 of the display image 701.

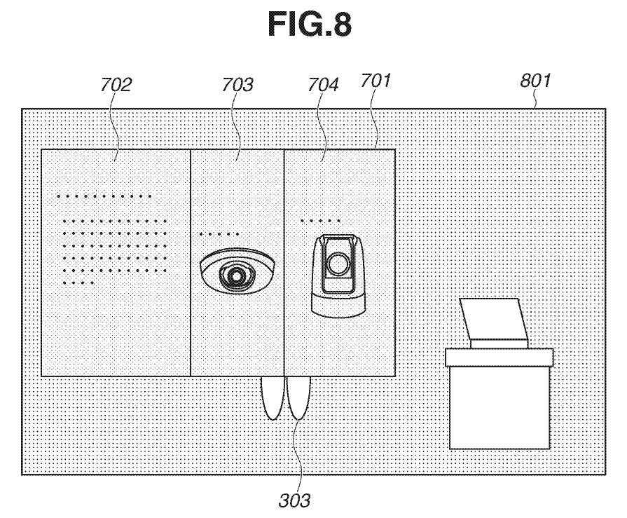

FIG. 8 is a diagram illustrating an example of a composite image 801 in a case where an importance degree of a display region is set to a value larger than a threshold importance degree when a person image and a display region of a display image overlap each other, for example. The example in FIG. 8 illustrates the composite image 801 composited in a state in which the display regions 703 and 704 of the display image 701 illustrated in FIG. 7, and the image of the person 303 overlap each other. Importance degrees of the display regions 703 and 704 are set to values larger than or relatively larger than the threshold importance degree 708.

In a case where the display region 703 and the image of the person 303 overlap each other as illustrated in FIG. 8, the composite processing unit 102 determines that an overlap occurs between the display region 703 and the person 303 based on a positional relationship between the display region 703 and the person 303. The composite processing unit 102 then transmits information regarding the importance degree 706 of the display region 703 and the threshold importance degree 708 to the foreground determination unit 105 together with the overlap determination result. The foreground determination unit 105 determines which of the person 303 and the display region 703 is to be placed in the foreground image based on the overlap determination result obtained by the composite processing unit 102, the importance degree 706, and the threshold importance degree 708. In this example, since the importance degree 706 of the display region 703 is larger than the threshold importance degree 708, the foreground determination unit 105 determines to set the display region 703 as the foreground image, and then transmits the determination result to the composite processing unit 102.

Similarly, the composite processing unit 102 determines that an overlap occurs between the display region 704 and the person 303 based on the positional relationship between the display region 704 and the person 303. The composite processing unit 102 then transmits information regarding the importance degree 707 of the display region 704 and the threshold importance degree 708 to the foreground determination unit 105 together with the overlap determination result. The foreground determination unit 105 determines which of the image of the person 303 and the display region 704 is to be placed in the foreground image based on the overlap determination result obtained by the composite processing unit 102, the importance degree 707, and the threshold importance degree 708. In this example, since the importance degree 707 of the display region 704 is larger than the threshold importance degree 708, the foreground determination unit 105 determines to set the display region 704 as a foreground image, and then transmits the determination result to the composite processing unit 102.

The composite processing unit 102 then performs processing of compositing the image of the person 303 and the display regions 703 and 704 with the display regions 703 and 704 being set as the foreground image based on the determination result obtained by the foreground determination unit 105.

Consequently, as exemplified in FIG. 8, the composite processing unit 102 generates the composite image 801 in which the display regions 703 and 704 are set as the foreground image, and substantially the entire body of the person 303 (i.e., substantially the entire body excluding portions of the legs) is occluded.

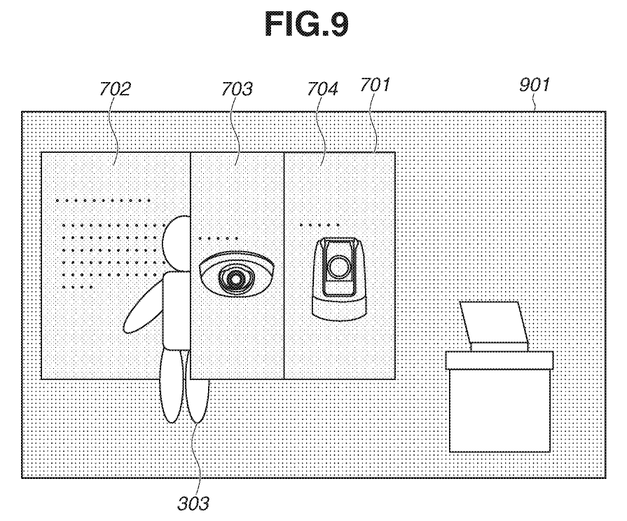

FIG. 9 is a diagram illustrating an example of a composite image 901 in a case where a person and two display regions of a display image overlap each other, and for example, an importance degree of one of the display regions is set to a value equal to or larger than a threshold importance degree, while an importance degree of the other display region is set to a value smaller than the threshold importance degree. The example in FIG. 9 illustrates the composite image 901 composited in a state in which the display regions 702 and 703 of the display image 701 illustrated in FIG. 7, and the person 303 overlap each other. It is on the assumption that the importance degree 705 of the display region 702 is set to a value equal to or larger than the threshold importance degree 708, and the importance degree 706 of the display region 703 is set to a value smaller than the threshold importance degree 708.

In a case where the display regions 702 and 703, and the person 303 overlap as illustrated in FIG. 9, the composite processing unit 102 determines that an overlap occurs between the display regions 702 and 703 and the person 303 based on the positional relationship between the display regions 702 and 703, and the person 303. The composite processing unit 102 then transmits information regarding the importance degrees 705 and 706 of the display regions 702 and 703 and the threshold importance degree 708 to the foreground determination unit 105 together with the overlap determination result. The foreground determination unit 105 determines which of the image of the person 303 and display regions 702 and 703 is to be placed in the foreground image based on the overlap determination result obtained by the composite processing unit 102, the importance degrees 705 and 706, and the threshold importance degree 708. In this example, since the importance degree 705 of the display region 702 is smaller than the threshold importance degree 708, the foreground determination unit 105 determines to set the image of the person 303 as the foreground image. On the other hand, since the importance degree 706 of the display region 703 is equal to or larger than the threshold importance degree 708, the foreground determination unit 105 determines to set the display region 703 as the foreground image.

As a result, the composite processing unit 102 performs processing of compositing the image of the person 303 and the display regions 702 and 703 with the display region 702 being set as the background image and the display region 703 being set as the foreground image based on the determination result obtained by the foreground determination unit 105. Consequently, as exemplified in FIG. 9, the composite processing unit 102 generates the composite image 901 in which the person 303 is set as the foreground image in the display region 702, and the person 303 is set as the background image in the display region 703.

In the example of FIG. 7 described above, the display region 702 is, for example, a region including small characters or the like in a slide for presentation, and the display regions 703 and 704 are regions including photos, illustration, or the like. Further, the importance degree 705 of the display region 702 is smaller than the threshold importance degree 708, whereas the importance degrees 706 and 707 of the display regions 703 and 704 are set to values larger than the threshold importance degree 708. For this reason, a composite image reflecting the intention of the user can be generated in which the display region 702 including small characters or the like is set as the background image, i.e., the display regions 703 and 704 of photos, illustration, or the like, are set as the foreground image when the display image 701 and the person 303 overlap each other.

According to the image processing apparatus 101 according to the embodiment, different importance degrees can be set for a plurality of divided display regions, and thus a portion to be seen in the foreground, a portion not to be seen in the foreground, and the like, can be set, enabling a more effective presentation.

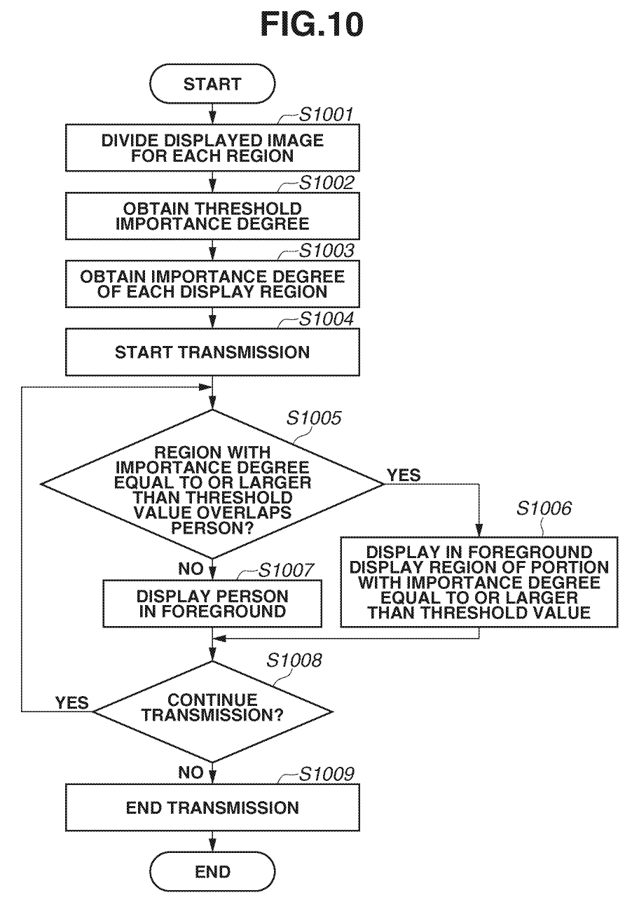

FIG. 10 is a flowchart illustrating a procedure for image processing performed by the image processing apparatus 101 according to the second embodiment.

In step S1001, the composite processing unit 102 divides a display image into a plurality of display regions based on division setting information set by the user and input from the IF unit 106.

In step S1002, similarly to the above-described embodiment, the importance degree storage unit 103 stores a threshold importance degree set by the user.

In step S1003, the importance degree storage unit 103 obtains an importance degree set by the user for each display region of the display image using a desired method and input from the IF unit 106 to store the importance degree.

Further, the order of steps S1002 and S1003 may be reversed.

In step S1004, after the storage of the importance degrees and the threshold importance degree described above, the image processing apparatus 101 starts transmitting an image from the IF unit 106. Further, in the embodiment, similarly to the above-described embodiment, during the image transmission, the image processing apparatus 101 performs person detection with the person detection unit 104 at a regular cycle, and performs processing of transmitting position information about the detected person to the composite processing unit 102.

In step S1005, the composite processing unit 102 determines for each display region whether the importance degree is equal to or larger than the threshold importance degree (or may be larger than the threshold importance degree), and further determines whether a display region having an importance degree equal to or larger than the threshold importance degree overlaps a region of a person. Then, if the composite processing unit 102 determines that a display region having an importance degree equal to or larger than the threshold importance degree overlaps the region of the person (YES in step S1005), the processing proceeds to step S1006; Otherwise (NO in step S1005), the processing proceeds to step S1007.

If the processing proceeds to step S1006, i.e., if a display region having an importance degree equal to or larger than the threshold importance degree overlaps the region of the person, in step S1006, the foreground determination unit 105 determines to display the display region in the foreground based on the importance degree and the threshold importance degree. The composite processing unit 102 then generates a composite image by compositing the display region and the image of the person with the display region being placed in the foreground.

On the other hand, if the processing proceeds to step S1007, in step S1007, the foreground determination unit 105 determines to display the image of the person in the foreground without determining which of the images is to be set as the foreground image based on the importance degree and the threshold importance degree, and the composite processing unit 102 generates a composite image by compositing the display region and the image of the person with the image of the person being placed in the foreground. Thus, if a display region having an importance degree equal to or larger than the threshold importance degree does not overlap a person, or if the importance degree of a display region overlapping a person is smaller than the threshold importance degree, the foreground determination unit 105 determines to display the image of the person in the foreground, and the composite processing unit 102 generates a composite image in which the image of the person is placed in the foreground.

Further, in the second embodiment, while an example is described in which the foreground and background determination is performed when a display region having an importance degree equal to or larger than the threshold importance degree overlaps a person, the foreground and background determination may also be performed based on the importance degree and the threshold importance degree in a case where a display region having an importance degree equal to or larger than the threshold importance degree does not overlap the person. Thus, although it is difficult to visually recognize the front-back relationship between an image of a person and a display region from a composited image, the image processing apparatus 101 also performs relative foreground and background ordering between the image of the person and the display region in a case where the image of the person and the display region do not overlap. This makes it possible, in a case where the image of the person and the display region overlap each other later, for the user to visually recognize the front-back relationship between the image of the person and the display region.

After step S1006 or step S1007, the processing of the image processing apparatus 101 proceeds to step S1008. If the processing proceeds to step S1008, in step S1008, the IF unit 106 determines whether to continue the transmission of the composite image by monitoring a signal input from the outside. If the IF unit 106 determines to continue the transmission of the composite image (YES in step S1008), the processing of the image processing apparatus 101 returns to step S1005. On the other hand, if the IF unit 106 determines to end the transmission of the composite image (NO in step S1008), the processing proceeds to step S1009. In step S1009, the processing of this flowchart ends.

### Third Embodiment

As a third embodiment, processing will be described of exemplary setting an image of a person as the foreground image if the area of an overlap region between a person and a display region having an importance degree equal to or larger than a threshold importance degree is equal to or smaller than a threshold preset by the user (hereinafter, will be referred to as a threshold area). A display image, a display region, an importance degree, and a threshold importance degree used in the description of the third embodiment are the same as those described in the second embodiment.

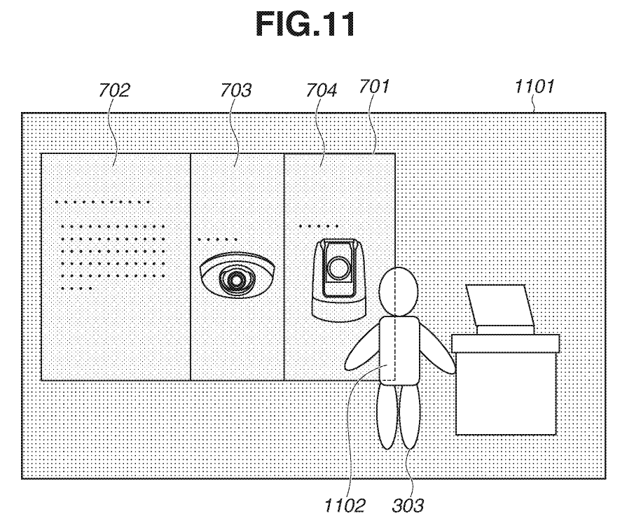

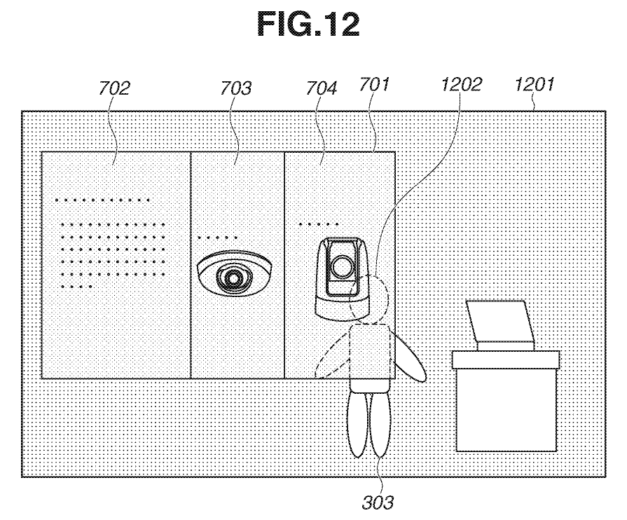

FIGS. 11 and 12 each illustrate an example in which a display region 704 having an importance degree larger than a threshold importance degree and the image of the person 303 overlap in a partial region. Hereinafter, the region of the overlap between the display region and the person will be referred to as an overlap region. Further, in the third embodiment, the composite processing unit 102 has an area acquisition function of sequentially calculating an area of an overlap region, in addition to the above-described functions described in the first and second embodiments. Further, the foreground determination unit 105 according to the third embodiment compares an area of an overlap region calculated by the composite processing unit 102 with a preset threshold area to perform foreground and background determination based on the comparison result.

FIG. 11 illustrates an example of a composite image 1101 generated by the composite processing unit 102, in which, since the area of an overlap region 1102 between the display region 704 and the person 303 is equal to or smaller than the threshold area, the foreground determination unit 105 determines the image of the person 303 to be placed in the foreground image, and the display region 704 is composited with the image of the person 303 set as the foreground image. In a case where the area of the overlap region 1102 is equal to or smaller than the threshold area, the composite processing unit 102 represents the display region 704 as the background in the overlap region 1102, as a linear outline, for example.

FIG. 12 illustrates an example of a composite image 1201 generated by the composite processing unit 102, in which, since the area of an overlap region 1202 between the display region 704 and the person 303 is larger than the threshold area, the foreground determination unit 105 determines the display region 704 to be placed in the foreground image, and the display region 704 as the foreground image is composited with the image of the person 303. In a case where the area of the overlap region 1202 is larger than the threshold area, the composite processing unit 102 represents the person 303 as the background in the overlap region 1202, as a linear outline, for example.

As described above, in the third embodiment, foreground switching does not occur until an area of an overlap region between a display region and a person exceeds a threshold area, making it possible to avoid reduction in visibility due to frequent switching between the foreground and the background. In the embodiment, the case is described as an example where the importance degree is set for each display region as described in the above-described second embodiment, but the embodiment is also applicable to a case where the importance degree is set for each display image as in the first embodiment.

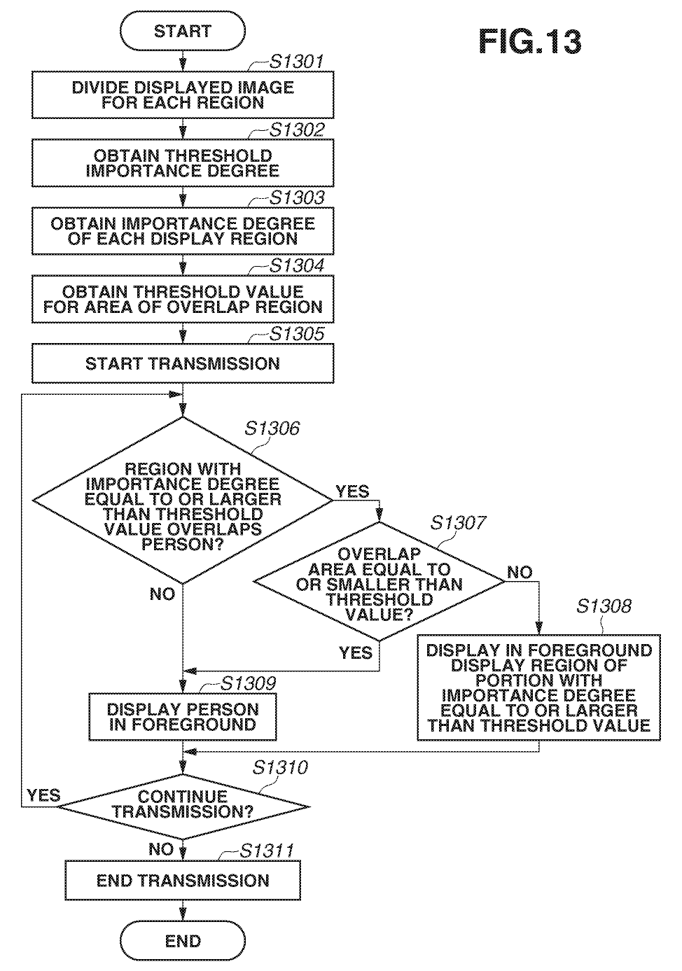

FIG. 13 is a flowchart illustrating a procedure for image processing performed by the image processing apparatus 101 according to the third embodiment.

In step S1301, similarly to step S1001 described above, the composite processing unit 102 divides a display image into a plurality of display regions based on division setting information set by the user.

In step S1302, similarly to the embodiments described above, the importance degree storage unit 103 obtains a threshold importance degree set by the user to store the threshold importance degree.

In step S1303, similarly to the embodiments described above, the importance degree storage unit 103 obtains an importance degree set by the user for each display region of the display image to store the importance degree.

In step S1304, the foreground determination unit 105 obtains a threshold area for an area of an overlap region set by the user using a desired method and input from the IF unit 106 to store the threshold area.

Further, the processing in steps S1302 to S1304 may be performed in any order.

In step S1305, after the storage of the importance degree and the threshold importance degree above described, the image processing apparatus 101 starts transmitting an image from the IF unit 106. Further, in the embodiment, similarly to the embodiments described above, during the image transmission, the image processing apparatus 101 performs person detection with the person detection unit 104 at a regular cycle, and performs processing of transmitting position information about the detected person to the composite processing unit 102.

In step S1306, the composite processing unit 102 determines whether the importance degree of each display region is equal to or larger than the threshold importance degree, and further determines whether a display region having an importance degree equal to or larger than the threshold importance degree overlaps a region of a person. Then, if the composite processing unit 102 determines that a display region having an importance degree equal to or larger than the threshold importance degree overlaps the region of the person (YES in step S1306), the processing proceeds to step S1307; Otherwise (NO in step S1306), the processing proceeds to step S1309.

If the processing proceeds to step S1307, in step S1307, the foreground determination unit 105 determines whether the area of the overlap region is equal to or smaller than the threshold area. If the foreground determination unit 105 determines that the area of the overlap region is equal to or smaller than the threshold area (YES in step S1307), the processing proceeds to step S1309. On the other hand, if the area of the overlap region is larger than the threshold area (NO in step S1307), the processing proceeds to step S1308.

If the processing proceeds to step S1309, in step S1309, the foreground determination unit 105 determines to set the display region as the foreground image, and the composite processing unit 102 generates a composite image by compositing the display region and the image of the person with the display region being placed in the foreground.

On the other hand, if the processing proceeds to step S1308, in step S1308, the foreground determination unit 105 determines to display the image of the person in the foreground without determining which of the images is to be set as the foreground image based on the importance degree and the threshold importance degree, and the composite processing unit 102 generates a composite image by compositing the display region and the image of the person with the image of the person being placed in the foreground.

After step S1308 or step S1309, the processing of the image processing apparatus 101 proceeds to step S1310. If the processing proceeds to step S1310, in step S1310, similarly to the embodiments above described, the IF unit 106 determines whether to continue the transmission of the composite image. Then, if the IF unit 106 determines to continue the transmission of the composite image (YES in step S1310), the processing of the image processing apparatus 101 returns to step S1306. On the other hand, if the IF unit 106 determines to end the transmission of the composite image (NO in step S1310), the processing proceeds to step S1311. In step S1311, the processing of this flowchart ends.

### Fourth Embodiment

As a fourth embodiment, an example will now be described in which the composite processing unit 102 further has a function of dividing a display image into display regions using a trained model. A display image, a display region, an importance degree, and a threshold importance degree used in the description of the fourth embodiment are the same as those described in the second embodiment.

In the embodiment, the trained model is obtained by preliminarily learning with learning data. The learning data refers to teaching data prepared in advance, and a trained model is obtained by training a system in advance using image data and labels. In the embodiment, the type of learning is assumed to be classification learning that predicts which class certain data belongs to. The classification learning uses images in learning data to which labels are assigned, so that an object appearing in newly input data to which no label is assigned can be identified. A label may include not only a name of an object appearing in an image, but an importance degree of the object. By inputting a display image to the composite processing unit 102 having a trained model trained by this method, the composite processing unit 102 can divide a display image into display regions. Further, the composite processing unit 102 can add an importance degree to each display region by recognizing a pattern with reference to a library created through the learning process that uses learning data.

In the embodiment, while an example is described of adding importance degrees by recognizing patterns with reference to a library created through the learning process that uses learning data, it is also possible to automatically determine importance degrees using an autonomous system having a self-determination capability. In this example, the user does not need to prepare a large amount of teaching data related to importance degrees, a processing unit of the system can automatically make a determination regarding importance degrees, and propose the determined importance degrees to the user. The user can set for a display region an importance degree selected from among these proposed importance degrees.

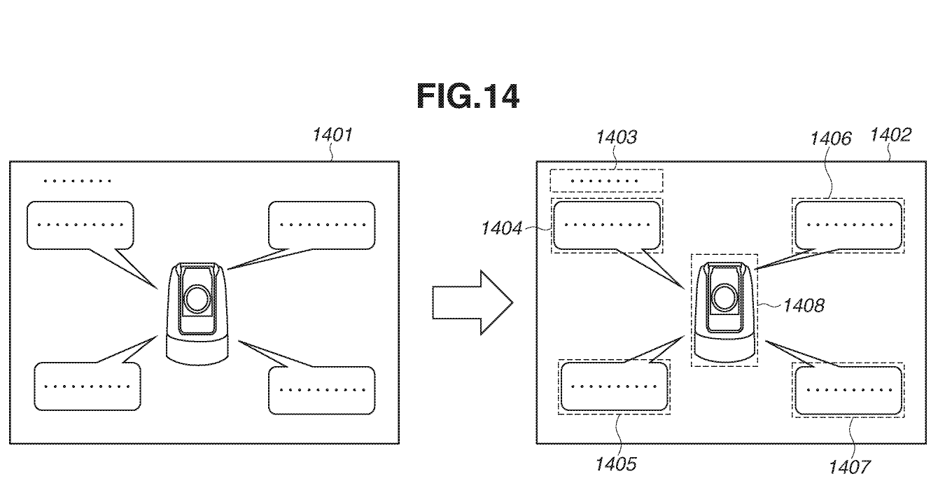

FIG. 14 is a diagram for describing display image division processing performed by the composite processing unit 102 according to the fourth embodiment.

A display image 1401 illustrated in FIG. 14 is an example of a display screen of a slide used for a presentation. For the sake of description of the division processing according to the embodiment, examples of the display image 1401 in FIG. 14 include image data, such as a photo, and character data for the description or the like.

The composite processing unit 102 performs processing of automatically dividing the display image 1401 into display regions using the above-described trained model to acquire an image (hereinafter, will be referred to as an automatically-processed image 1402) obtained through the automatic division processing. The automatically-processed image 1402 illustrates an example of an image including display regions 1403 to 1408, which is obtained by performing processing of automatically dividing the display image 1401 for each image and for each piece of text data. Further, in the embodiment, the composite processing unit 102 automatically adds an importance degree using the trained model, and performs division processing on the display regions 1403 to 1408. In a case where the automatic division processing includes processing of adding an importance degree, all that the user is to do is set a threshold importance degree. With the image processing apparatus 101 in the fourth embodiment, this eliminates the need for the user to set display regions in a display image, and to set an importance degree for each display region.

In the embodiment, an example is described of automatically setting an importance degree using a trained model together with the division processing on the display regions 1403 to 1408, but importance degrees of the display regions 1403 to 1408 may be individually set by the user similarly to the embodiments above described. In this manner, the image processing apparatus 101 according to the fourth embodiment can also perform processing similar to that in the embodiments described above.

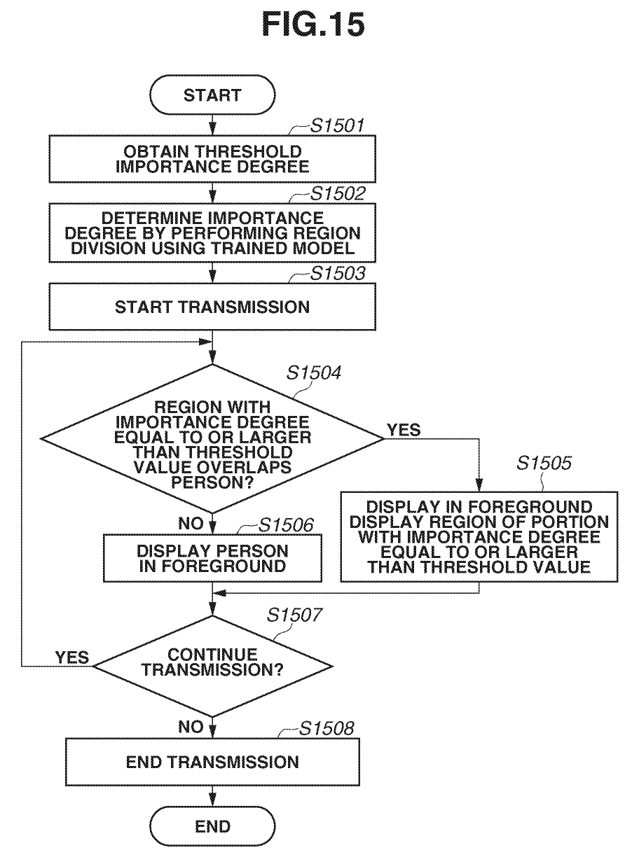

FIG. 15 is a flowchart illustrating a procedure for image processing performed by the image processing apparatus 101 according to the fourth embodiment.

In step S1501, similarly to the above-described embodiments, the importance degree storage unit 103 stores a threshold importance degree set by the user.

In step S1502, the composite processing unit 102 divides a display image into display regions using the above-described trained model to determine an importance degree of each display region.

In step S1503, after the storage of the importance degree and the threshold importance degree described above, similarly to the above-described embodiments, the image processing apparatus 101 starts transmitting an image from the IF unit 106.

In step S1504, similarly to the above-described embodiments, the composite processing unit 102 determines whether the importance degree of each display region is equal to or larger than the threshold importance degree, and further determines whether a display region having an importance degree equal to or larger than the threshold importance degree overlaps a region of a person. Then, if the composite processing unit 102 determines that a display region having an importance degree equal to or larger than the threshold importance degree overlaps the region of the person (YES in step S1504), the processing proceeds to step S1505; Otherwise (NO in step S1504), the processing proceeds to step S1506.

If the processing proceeds to step S1505, in step S1505, the composite processing unit 102 generates a composite image by compositing the display region and the image of the person with a display region as a portion having an importance degree equal to or larger than the threshold importance degree set as the foreground.

On the other hand, if the processing proceeds to step S1506, the composite processing unit 102 generates a composite image by compositing the display image and the image of the person with the image of the person being placed in the foreground.

After step S1505 or step S1506, the processing of the image processing apparatus 101 proceeds to step S1507. If the processing proceeds to step S1507, similarly to the above-described embodiments, in step S1507, the IF unit 106 determines whether to continue the transmission of the composite image. Then, if the IF unit 106 determines to continue the transmission of the composite image (YES in step S1507), the processing of the image processing apparatus 101 returns to step S1504. On the other hand, if the IF unit 106 determines to end the transmission of the composite image (NO in step S1507), the processing proceeds to step S1508. In step S1508, the processing of this flowchart ends.

### Fifth Embodiment

As a fifth embodiment, an example will now be described in which the image processing apparatus 101 performs image processing based on a time period for which a person and a display image overlap. Further, in the embodiment, a display image will be described as an example, but the above-described display region may be used. In the fifth embodiment, the foreground determination unit 105 has a time measurement function of measuring the time period for which a display image having an importance degree equal to or larger than a threshold importance degree overlaps a person to determine whether the measured time period is equal to or larger than a predetermined threshold (will be referred to as a threshold time period). A display image, a display region, an importance degree, and a threshold importance degree used in the description of the fifth embodiment are the same as those described in the above-described embodiments.

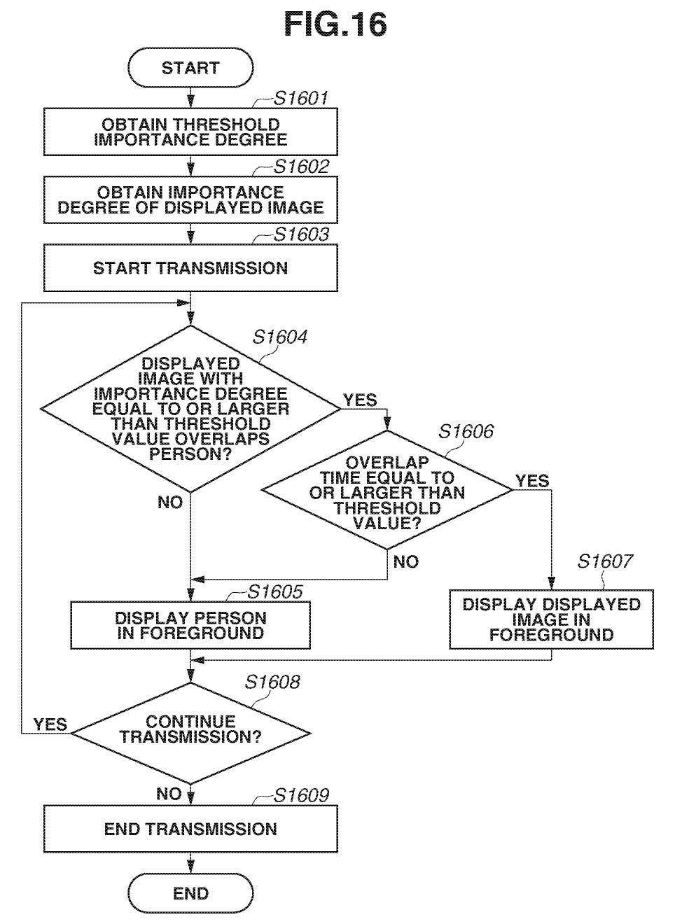

FIG. 16 is a flowchart illustrating a procedure for image processing performed by the image processing apparatus 101 according to the fifth embodiment.

In step S1601, similarly to the above-described embodiments, the importance degree storage unit 103 stores a threshold importance degree set by the user.

In step S1602, similarly to the above-described embodiments, the importance degree storage unit 103 stores an importance degree set for each display image.

In step S1603, similarly to the above-described embodiments, the image processing apparatus 101 starts transmitting an image from the IF unit 106.

In step S1604, similarly to the above-described embodiments, the composite processing unit 102 determines whether an importance degree of a display image is equal to or larger than the threshold importance degree, and further determines whether a display image having an importance degree equal to or larger than the threshold importance degree overlaps a region of a person. Then, if the composite processing unit 102 determines that a display image with an importance degree equal to or larger than the threshold importance degree overlaps the region of the person (YES in step S1604), the processing proceeds to step S1606; Otherwise (NO in step S1604), the processing proceeds to step S1605.

If the processing proceeds to step S1606, in step S1606, the foreground determination unit 105 determines whether a time period for which a display image having an importance degree equal to or larger than the threshold importance degree overlaps the region of the person is equal to or larger than a predetermined threshold (will be referred to as a threshold time period).

In this case, the threshold time period is assumed to be a parameter preset by the user. The threshold time period may be defined as an absolute value, such as a predetermined number of seconds, or may be a stepwise value adjustable via a pull-down menu or a scale bar on a GUI. The foreground determination unit 105 compares the overlap time period with the threshold time period to determine whether the overlap time period is equal to or larger than the threshold time period (may be longer than the threshold time period).

Then, if the foreground determination unit 105 determines that the overlap time is equal to or larger than the threshold time period (YES in step S1606), the processing proceeds to step S1607. On the other hand, if the foreground determination unit 105 determines that the overlap time period is smaller than the threshold time period (NO in step S1606), the processing proceeds to step S1605.

If the processing proceeds to step S1607, in step S1607, the composite processing unit 102 generates a composite image by compositing the display image and the image of the person with the display image being placed in the foreground.

On the other hand, if the processing proceeds to step S1605, in step S1605, the composite processing unit 102 generates a composite image by compositing the display image and the image of the person with the image of the person being placed in the foreground.

After step S1605 or step S1607, the processing of the image processing apparatus 101 proceeds to step S1608. If the processing proceeds to step S1608, similarly to the above-described embodiments, in step S1608, the IF unit 106 determines whether to continue the transmission of the composite image. Then, if the IF unit 106 determines to continue the transmission of the composite image (YES in step S1608), the processing of the image processing apparatus 101 returns to step S1604. On the other hand, if the IF unit 106 determines to end the transmission of the composite image (NO in step S1608), the processing proceeds to step S1609. In step S1609, the processing of this flowchart ends.

According to the fifth embodiment, repeated switching between the foreground and the background in an image within a short time period can be prevented, generating a composite image with good visibility for the user viewing the composite image.

### Sixth Embodiment

As a sixth embodiment, an example will now be described in which the image processing apparatus 101 changes the transparency of an image of a person based on a time period for which a display image having an importance degree equal to or larger than a threshold importance degree overlaps the person.

Further, while in the embodiment, an example will be described of a display image, the above-described display region may be used. In the sixth embodiment, a display image, a display region, an importance degree, and a threshold importance degree are the same as those described in the above-described embodiments.

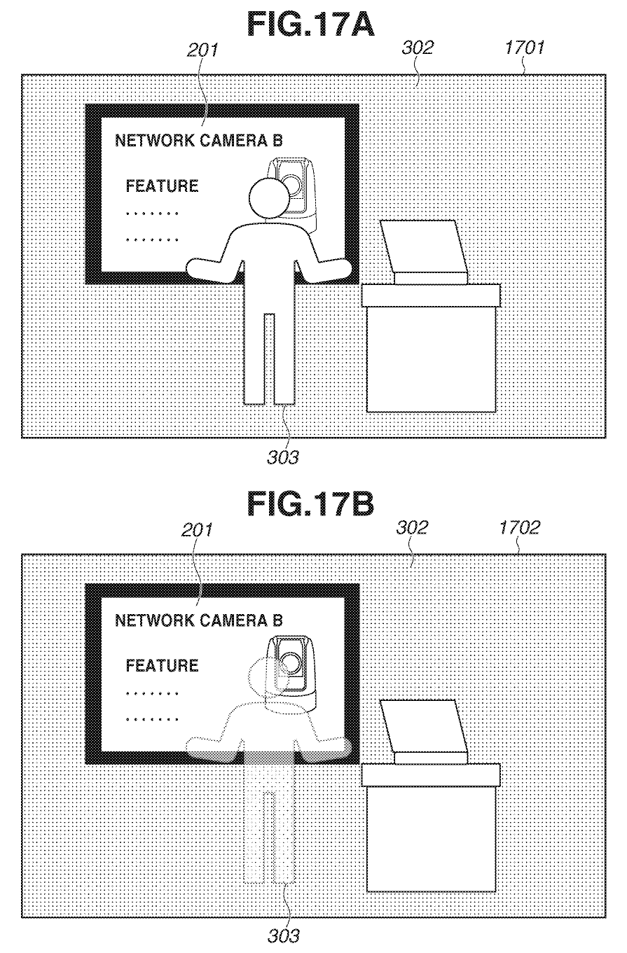

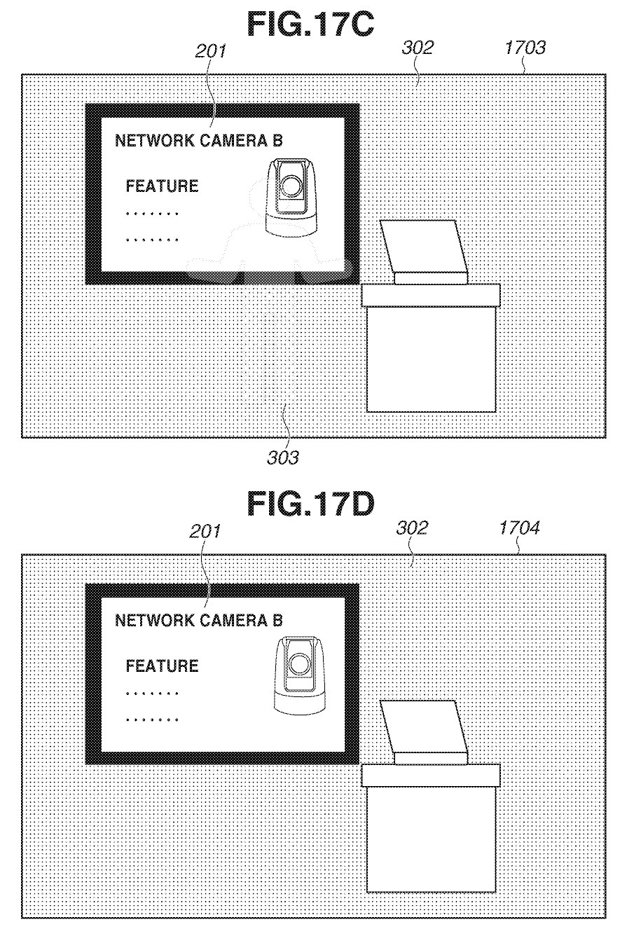

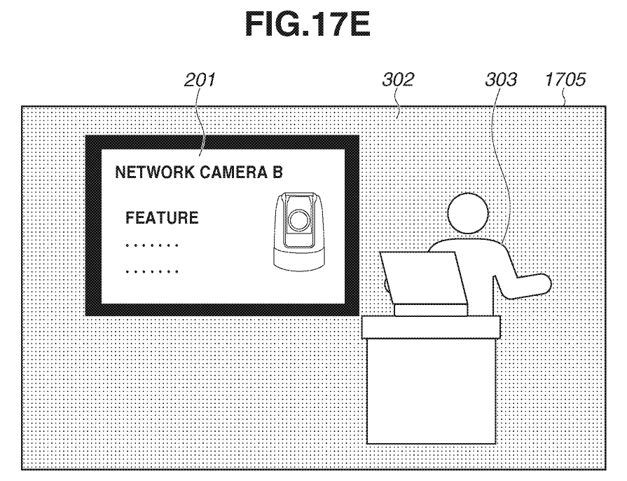

FIGS. 17A,17B, 17C, 17D and 17E each illustrate a composite image example in which the transparency of an image of a person is changed based on a time period for which a display image having an importance degree equal to or larger than a threshold importance degree overlaps a person according to the sixth embodiment.

A composite image 1701 illustrated in FIG. 17A illustrates a moment at which a portion of the person 303 and a portion of the display image 201 overlap each other due to movement of the person 303. Even in a case where the importance degree of the display image is equal to or larger than the threshold importance degree, the composite processing unit 102 according to the embodiment composites the display image and the image of the person with the image of the person being set as the foreground image when the display image and the image of the person overlap each other. Thus, the composite image 1701 illustrated in FIG. 17A is captured at the time point at which the image of the person 303 and the display image 201 overlap each other, and thus the composite image 1701 is created so that the image of the person 303 is set as the foreground image, and the display image 201 is set as the background image.

A composite image 1702 in FIG. 17B illustrates an example of a composite image obtained after the lapse of a certain time period while the image of the person 303 and the display image 201 remain overlapping as illustrated in FIG. 17A. The composite processing unit 102 according to the embodiment has a time measurement function of measuring a time period for which a state where a display image having an importance degree equal to or larger than a threshold importance degree overlaps a person continues after the overlap occurs, and a function of comparing the measured time period with a threshold corresponding to a preset certain time period. In the embodiment, a threshold corresponding to a preset time period is referred to as a threshold period. The composite processing unit 102 according to the embodiment changes the transparency of a person at a time when the measured time period for which a display image having an importance degree equal to or larger than a threshold importance degree overlaps the person exceeds a threshold period, and generates a composite image by compositing the image of the person of which the transparency has been changed and the display image. Compared with the composite image 1701 in FIG. 17A, the composite image 1702 illustrated in FIG. 17B has an increased transparency of the person 303, allowing the user to visually recognize the details of the display image 201 even in a portion where the person 303 overlaps the display image 201.

Further, in the embodiment, after the measured time period exceeds the threshold period, if the state in which the person and the display image overlap continues, the composite processing unit 102 according to the embodiment generates a composite image by adjusting the transparency of the person so that the transparency increases as the overlap time period becomes longer. The amount of change in the transparency of the person when the transparency increases based on the continuation time period may be constant or may vary. In the embodiment, an example is described of performing transparency adjustment so that the transparency of a person increases as the time period for which the person and a display image overlap becomes longer, but the adjustment is not limited to the example. For example, the composite processing unit 102 may set the transparency of a person to 0% (i.e., opaque) until the time when the person and a display image exceed a threshold period, and may set the transparency of the person to 100% (fully transparent) after the overlap time period exceeds the threshold period.

A composite image 1703 in FIG. 17C illustrates an example where the transparency of the person is further increased compared with the example in FIG. 17B, due to the state in which the person overlaps the display image continues.

A composite image 1704 in FIG. 17D illustrates an example where, as the time period during which the person overlaps the display image increases, the transparency of the person reaches 100% (fully transparent), and the display image 201 becomes completely visible.

In a case where an overlapping state of a person and a display image transitions to a non-overlapping state, the composite processing unit 102 according to the embodiment performs transparency adjustment so as to decrease the transparency of the person, contrary to the control performed when the person overlaps the display image. Further, at a time point when the state transitions from the overlapping state to the non-overlapping state of the person and the display image, the composite processing unit 102 may set the transparency of the person to 0% (i.e., opaque).

A composite image 1705 in FIG. 17E illustrates an example where the person and the display image transition from the overlapping state to the non-overlapping state. While the person is in the fully transparent state in the composite image 1704 of FIG. 17D, FIG. 17E illustrates that the transparency of the person is set to 0%, indicating return to a state in which the person exists on the composite image 1705.

According to the sixth embodiment, changing the transparency of a person based on the time period for which a display image overlaps the person makes it possible to avoid poor visibility caused by switching between the foreground image and the background image and to provide an image with smooth switching between the foreground image and the background image to the user viewing the image.

As described above, any of the first to sixth embodiments can provide a composite image reflecting the intention of the user who creates an image.

In each embodiment described above, an example has been described in which an importance degree and a threshold importance degree are set for display images, but an importance degree and a threshold importance degree may be set for an image of a person. Further, an image of a person may be divided into a plurality of image regions corresponding to body parts, such as a head, hands, a torso, and legs, and an importance degree and a threshold importance degree may be set for each image region.

Further, in each embodiment described above, an image of a person is used as an example of the first image, but the first image is not limited to an image of a person. For example, the first image may be an image of another object that moves or changes in shape, such as a vehicle, a mobile robot, a drone, or an animal. In this case, the person detection unit 104 of the above-described embodiments has a function of an object detection unit that detects a vehicle, a mobile robot, a drone, or an animal from a moving image as a specific object. In addition, the second image is not limited to a presentation material, a photo, or a display image for presentation, and may be other types of images.

The disclosure can also be implemented by processing in which a program for carrying out one or more functions of the above-described embodiments is supplied to a system or an apparatus via a network or a storage medium, and one or more processors in a computer of the system or the apparatus read and execute the program. Further, the disclosure can also be implemented with a circuit (for example, an ASIC) that carries out one or more functions.

All of the above-described embodiments each show merely an example of a specific implementation for carrying out the disclosure, and the technical scope of the disclosure is not to be construed in a limited manner by those embodiments. Thus, the disclosure can be implemented in various forms without departing from the technical idea or the essential features thereof.

According to the disclosure, a composite image reflecting the intention of the user can be provided.

Embodiment(s) of the disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2025-076788, filed May 2, 2025, which is hereby incorporated by reference herein in its entirety.

What is claimed is:

1. An image processing apparatus comprising:
at least one processor; and
at least one memory coupled to the at least one processor storing instructions that, when executed by the at least one processor, cause the at least one processor to function as:
an acquisition unit configured to acquire a first image and a second image;
a determination unit configured to determine either the first image or the second image to be a foreground image based on an importance degree and a threshold importance degree set for the second image; and
a composition unit configured to composite the first image and the second image based on a result of the determination performed by the determination unit.

2. The image processing apparatus according to claim 1, further comprising a judgement unit configured to judge whether the first image overlaps the second image having the importance degree equal to or larger than the threshold importance degree,
wherein, in a case where the first image overlaps the second image having the importance degree equal to or larger than the threshold importance degree, the determination unit performs processing of determining either the first image or the second image to be the foreground image.

3. The image processing apparatus according to claim 1, further comprising an area acquisition unit configured to obtain an area of a region in which the first image overlaps the second image,
wherein, in a case where the area of the overlap region is larger than a threshold area, the determination unit performs processing of determining either the first image or the second image to be the foreground image.

4. The image processing apparatus according to claim 1, further comprising a measurement unit configured to measure a time period for which the first image overlaps the second image,
wherein, in a case where the time period for which the first image overlaps the second image is equal to or larger than a threshold time period, the determination unit performs processing of determining either the first image or the second image to be the foreground image.

5. The image processing apparatus according to claim 1, further comprising a measurement unit configured to measure a time period for which the first image and the second image overlap,
wherein, based on a length of the time period for which the first image and the second image overlap, the composition unit changes transparency of the first image to be composited.

6. The image processing apparatus according to claim 5, wherein the composition unit increases the transparency of the first image as the time period for which the first image overlaps the second image increases.

7. The image processing apparatus according to claim 1,
wherein the second image includes a plurality of image regions, and
wherein the determination unit determines either at least one of the image regions of the second image and the first image to be the foreground image using the importance degree set for each of the image regions.

8. The image processing apparatus according to claim 7, further comprising a setting unit configured to divide the second image into the plurality of image regions and set an importance degree for each of the divided image regions using a trained model.

9. The image processing apparatus according to claim 1, further comprising a detection unit configured to detect the first image from a captured moving image.

10. The image processing apparatus according to claim 9, wherein the first image is an image of a specific object included in the captured moving image.

11. The image processing apparatus according to claim 10, wherein the specific object is a person.

12. An image processing method to be executed by an image processing apparatus, the image processing method comprising:
acquiring a first image and a second image;
determining either the first image or the second image to be a foreground image based on an importance degree and a threshold importance degree set for the second image; and
compositing the first image and the second image based on a result of the determination performed in the determination.

13. The image processing method according to claim 12, further comprising judging whether the first image overlaps the second image having the importance degree equal to or larger than the threshold importance degree,
wherein, in a case where the first image overlaps the second image having the importance degree equal to or larger than the threshold importance degree, the determining performs processing of determining either the first image or the second image to be the foreground image.

14. The image processing method according to claim 12, further comprising obtaining an area of a region in which the first image overlaps the second image,
wherein, in a case where the area of the overlap region is larger than a threshold area, the determining performs processing of determining either the first image or the second image to be the foreground image.

15. The image processing method according to claim 12, further comprising measuring a time period for which the first image overlaps the second image,
wherein, in a case where the time period for which the first image overlaps the second image is equal to or larger than a threshold time period, the determining performs processing of determining either the first image or the second image to be the foreground image, and
wherein, based on a length of the time period for which the first image and the second image overlap, the compositing changes transparency of the first image to be composited.

16. A non-transitory computer readable storage medium storing a program for causing a computer to execute the image processing method, the image processing method comprising:
acquiring a first image and a second image;
determining either the first image or the second image to be a foreground image based on an importance degree and a threshold importance degree set for the second image; and
compositing the first image and the second image based on a result of the determination performed in the determination.

17. The non-transitory computer readable storage medium according to claim 16, further comprising judging whether the first image overlaps the second image having the importance degree equal to or larger than the threshold importance degree,
wherein, in a case where the first image overlaps the second image having the importance degree equal to or larger than the threshold importance degree, the determining performs processing of determining either the first image or the second image to be the foreground image.

18. The non-transitory computer readable storage medium according to claim 16, further comprising obtaining an area of a region in which the first image overlaps the second image,
wherein, in a case where the area of the overlap region is larger than a threshold area, the determining performs processing of determining either the first image or the second image to be the foreground image.

19. The non-transitory computer readable storage medium according to claim 16, further comprising measuring a time period for which the first image overlaps the second image,
wherein, in a case where the time period for which the first image overlaps the second image is equal to or larger than a threshold time period, the determining performs processing of determining either the first image or the second image to be the foreground image, and
wherein, based on a length of the time period for which the first image and the second image overlap, the compositing changes transparency of the first image to be composited.
